(19) United States
(12) Patent Application Publication
(10) Pub. No.: US 2012/0106013 A1
(43) Pub. Date: May 3, 2012

(54) CURRENT SENSE CIRCUIT AND BATTERY OVER-CURRENT PROTECTION CONTROLLER

(75) Inventors: Yang Yang, Wuxi (CN); Li-Min Lee, New Taipei City (TW); Shian-Sung Shiu, New Taipei City (TW)

(73) Assignee: GREEN SOLUTION TECHNOLOGY CO., LTD., New Taipei City (TW)

(21) Appl. No.: 13/182,456

(22) Filed: Jul. 14, 2011

(30) Foreign Application Priority Data
Oct. 29, 2010 (CN) 201010530352.X

(51) Int. Cl. H02H 3/08

(52) U.S. Cl. 361/87

(57) ABSTRACT

A battery over-current protection controller includes a current sense circuit, a first pin coupled to one end of the current detection circuit, a second pin, and a third pin. The second pin and the third pin are respectively coupled to a positive end and a negative end of a battery module. The current sense circuit includes a reference voltage generation unit, a voltage dividing unit, and a comparison unit. The reference voltage generation unit is coupled between the second pin and the third pin to generate a reference voltage. The voltage dividing unit has one end coupled to the reference voltage to thereby generate a voltage dividing signal. The comparison unit receives the voltage dividing signal and a current detection signal indicative of a value of a current flowing through the current detection circuit to thereby generate an over-current protection signal when the current is greater than the predetermined current.

### CROSS-REFERENCE TO RELATED APPLICATION

This application claims the priority benefit of China application serial no. 201010530352.X, filed on Oct. 29, 2010. The entirety of the above-mentioned patent application is hereby incorporated by reference herein and made a part of this specification.

### BACKGROUND OF THE INVENTION

1. Field of the Invention

The present invention relates to a current sense circuit and a battery over-current protection controller, and more particular, to a current sense circuit and a battery over-current protection controller with high precision and low temperature drift.

2. Description of Related Art

FIG. 1 is a circuit diagram of an existing battery over-current protection controller. As shown in FIG. 1, the battery over-current protection controller 100 includes a voltage detection unit 110, a logic control unit 120 and a current sense circuit 130. The voltage detection unit 110 detects a voltage of a battery module 10 to generate a voltage control signal DD. The current sense circuit 130 senses a current outputted by the battery module 10 to generate an over-current protection signal CC, so as to avoid an over-discharge state of the battery module 10. The logic control unit 120 receives the voltage control signal DD and the over-current protection signal CC to thereby control turn-on or turn-off of a charge-discharge switch 20. The voltage detection unit 110 is coupled between positive and negative ends of the battery module 10. When the voltage of the battery module 10 is over high due to over-charge or over low due to over-discharge, the voltage detection unit 110 outputs the voltage control signal DD to the logic control unit 120, such that the logic control unit 120 controls the charge-discharge switch 20 to turn off to avoid over-high or over-low voltage of the battery module 10. The current sense circuit 130 includes a reference voltage generation unit REF and a comparison unit 132. The reference voltage generation unit REF is coupled between a first common potential V1 and a zero potential (ground) to generate a reference voltage. The comparison unit 132 is coupled between the first common potential V1 and the zero potential (ground). The first common voltage V1 is the positive end of the battery module 10 and the zero potential is the negative end of the battery module 10. The comparison unit 132 receives, at a non-inverting input thereof, the reference voltage and receives, at an inverting input thereof, a current detection signal D1 generated by the current of the battery module 10 flowing through the charge-discharge switch 20, to thereby determine whether the current detection signal D1 is greater than the reference voltage, and generate an over-current protection signal CC when the level of the current detection signal D1 is less than the level of the reference voltage. The charge-discharge switch 20 is coupled between the positive end of the battery module 10 and a positive end 11 of a load. When the battery module 10 is in a discharge state, the charge-discharge switch 20 maintains turn-on, such that the discharge current of the battery module 10 flows through the charge-discharge switch 20 to the positive end 11 of the load. On the other hand, when the battery module 10 is in an over-discharge state, the charge-discharge switch 20 is turned off, such that the battery module 10 stops discharging.

However, when the battery module 10 using the battery over-current protection controller 100 consists of a plurality of battery cells connected in series such that the first common potential V1 is increased, the voltage endurance of the comparison unit 132 is required to increase accordingly. Therefore, high voltage components are required for the comparison unit 132, which would affect the precision of component matching and circuit layout area. In addition, the reference voltage generated by the conventional reference voltage generation unit REF varies with change in temperature, which may lead to imprecise determination of the comparison unit 132 or even damage of the battery module 10.

### SUMMARY OF THE INVENTION

As described above, the reference voltage tends to vary with change in temperature which may cause imprecision of current sense by the current sense circuit. In addition, if the circuit is utilized for a battery module consisting of a plurality of battery cells connected in series, the comparator is required to have increased voltage endurance. Accordingly, the present invention is directed to improve the precision of the current sense circuit by reducing a voltage drift of the reference voltage due to temperature change with a voltage dividing method. In addition, the reference voltage is used as the driving voltage for the comparator, which makes it possible for the comparator to use low voltage endurance components instead of high voltage endurance components.

In one embodiment, a current sense circuit is provided. The current sense circuit includes a reference voltage generation unit, a voltage dividing unit and a comparison unit. The reference voltage generation unit is coupled between a first common potential and a second common potential to generate a reference voltage. The voltage dividing unit has one end coupled to one of the first common potential and the second common potential to thereby generate a voltage dividing signal. The comparison unit is coupled to the reference voltage to receive power needed for operation and receive the voltage dividing signal and a current detection signal indicative of a value of a current to thereby determine whether the current is greater than a predetermined current. The comparison unit generates an over-current protection signal when the current is greater than the predetermined current.

In another embodiment, a battery over-current protection controller is provided. The battery over-current protection controller includes a first pin, a second pin, a third pin, and a current sense circuit. The first pin is coupled to one end of a current detection circuit. The second pin is coupled to a positive end of a battery module. The third pin is coupled to a negative end of the battery module. The current sense circuit is adapted to sense whether a current of the battery module is greater than a predetermined current according to a current detection signal indicative of a value of a current flowing through the current detection circuit. The current sense circuit includes a reference voltage generation unit, a voltage dividing unit, and a comparison unit. The reference voltage generation unit is coupled between the second pin and the third pin to generate a reference voltage. The voltage dividing unit has one end coupled to the reference voltage to thereby generate a voltage dividing signal according to the reference voltage. The comparison unit is adapted to receive the voltage dividing signal and the current detection signal to thereby generate an over-current protection signal when the current is greater than the predetermined current.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of an existing battery over-current protection controller.

FIG. 2 is a schematic diagram of a current sense circuit according to a preferred embodiment of the present invention.

FIG. 3 is a circuit diagram of a battery over-current protection controller according to a first preferred embodiment of the present invention.

FIG. 4 is a circuit diagram of a battery over-current protection controller according to a second preferred embodiment of the present invention.

FIG. 5 is a circuit diagram of a battery over-current protection controller according to third preferred embodiment of the present invention.

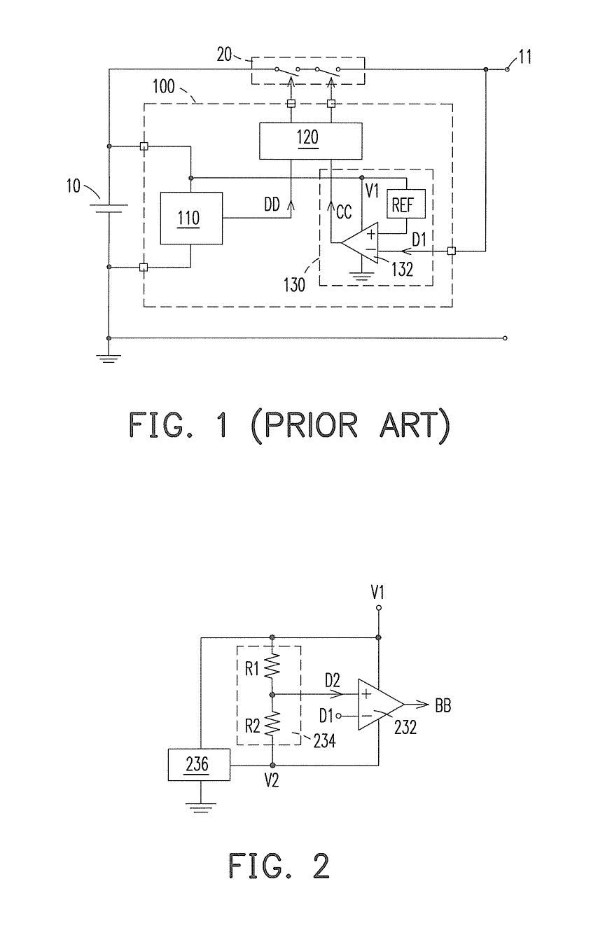

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a schematic diagram of a current sense circuit according to a preferred embodiment of the present invention. As shown, the current sense circuit senses, according to a current detection signal D1, whether a current represented by the current detection signal D1 is greater than a predetermined current value. The current sense circuit includes a reference voltage generation unit 236, a comparison unit 232, and a voltage dividing unit 234. The reference voltage generation unit 236 is coupled between a first common potential V1 and a second common potential (for example, ground, namely, a zero potential in this embodiment) to generate a reference voltage V2. The voltage dividing unit 234 has one end coupled to the first common potential V1 and another end coupled to the reference voltage V2 to thereby generate a voltage dividing signal D2. The voltage dividing unit 234 includes a first impedance R1 and a second impedance R2 connected in series, and so the reference voltage V2 is divided by the dividing ratio of the voltage dividing unit 234 to reduce a voltage drift of the reference voltage V2 due to temperature change. In this regard, the first impedance R1 is preferably less than the second impedance R2 in value, such that the divided voltage across the voltage dividing unit 234 is small so as to achieve an even lesser voltage drift. The comparison unit 232 is coupled between the first common potential V1 and the reference voltage V2 to receive power needed for operation. An inverting input terminal of the comparison unit 232 receives the current detection signal D1 and a non-inverting input terminal of the comparison unit 232 receives the voltage dividing signal D2, such that the comparison unit 232 determines whether the current detection signal D1 is less than the voltage dividing signal D2 and generates a current signal BB when the current detection signal D1 is less than the voltage dividing signal D2.

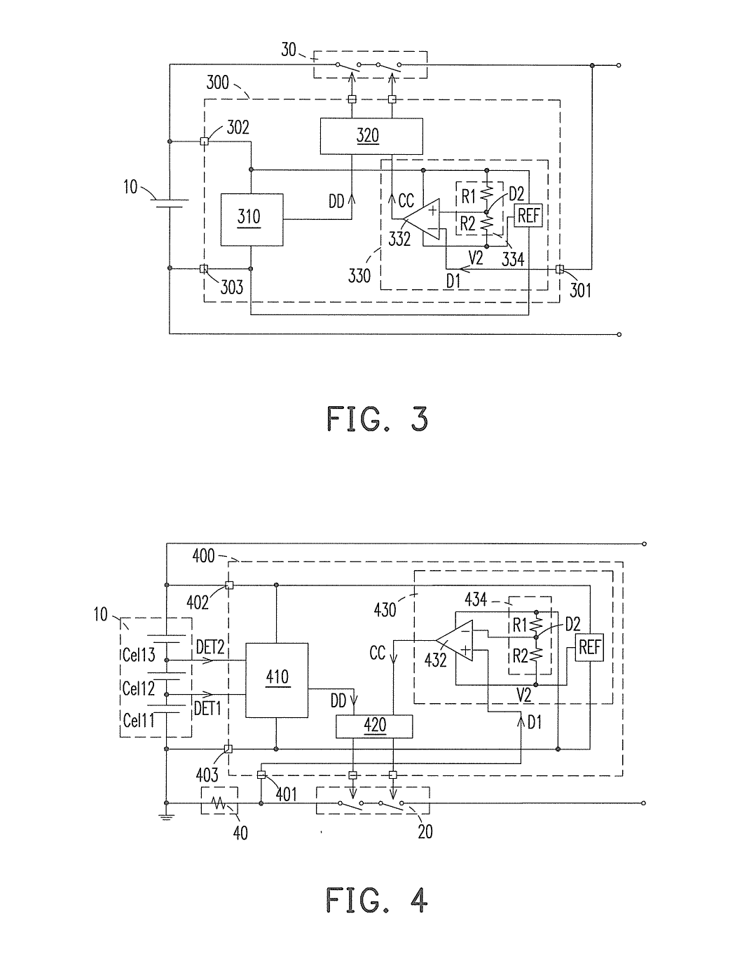

FIG. 3 is a circuit diagram of a battery over-current protection controller according to a first preferred embodiment of the present invention. The battery over-current protection controller 300 utilizes the current sense circuit of FIG. 2 to determine whether a current outputted by a battery module 10 in a discharge state is greater than a predetermined current. As shown in FIG. 3, the battery over-current protection controller 300 includes a voltage detection unit 310, a logic control unit 320, and a current sense circuit 330. The voltage detection unit 310 detects a voltage of the battery module 10 to generate a voltage control signal DD. A current detection circuit 30 is coupled to a positive end of the battery module 10 and generates a current detection signal D1 based on the value of a current flowing therethrough. The current sense circuit 330 receives the current detection signal D1 through a first pin 301 to thereby determine whether to generate an over-current protection signal CC. The logic control unit 320 receives the voltage control signal DD and the over-current protection signal CC to thereby control turn-on or turn-off of a charge-discharge switch. In the illustrated embodiment, the charge-discharge switch is the current detection circuit 30.

The current sense circuit 330 includes a reference voltage generation unit REF, a voltage dividing unit 334, and a comparison unit 332. The reference voltage generation unit REF is coupled between a second pin 302 and a third pin 303 to generate a reference voltage V2. The second pin 302 is coupled to the positive end of the battery module 10, and the third pin 303 is coupled to a negative end of the battery module 10. The voltage dividing unit 334 has one end coupled to the second pin 302 and another end coupled to the reference voltage V2 to generate a voltage dividing signal D2 according to the reference voltage V2. The reference voltage unit 334 includes a first impedance R1 and a second impedance R2 connected in series, and divides the reference voltage V2 to reduce a voltage drift of the reference voltage V2 due to temperature change. In this regard, the first impedance R1 is preferably less than the second impedance R2 in value, such that the divided voltage across the voltage dividing unit 334 is small so as to achieve an even lesser voltage drift. A non-inverting input terminal of the comparison unit 332 receives the voltage dividing signal D2 and an inverting input terminal of the comparison unit 332 receives the current detection signal D1. When the level of the current detection signal D1 is less than the level of the voltage dividing signal D2, the comparison unit 332 generates an over-current protection signal CC. That is, when the current flowing through the current detection circuit 30 is greater than a predetermined current, such that the voltage across the current detection circuit 30 is greater than a voltage thus making the level of the current detection signal D1 to be lower than the level of the voltage dividing signal D2, the comparison unit 332 generates an over-current protection signal CC. In this case, the logic control unit 320 controls the charge-discharge switch (i.e. the current detection circuit 30) to turn off, such that the battery module 10 stops discharging to avoid damage of the battery module 10 due to over-current.

The voltage detection unit 310 is coupled between the second pin 302 and the third pin 303 to detect whether the voltage of the battery module 10 is insufficient. When the voltage of the battery module 10 is less than a predetermined voltage (for example, when the battery module 10 is in an over-discharge state), the voltage detection unit 310 outputs a voltage control signal DD to the logic control unit 320. In this case, the logic control unit 320 controls the charge-discharge switch to turn off, such that the battery module 10 stops discharging to avoid damage of the battery module 10.

FIG. 4 is a circuit diagram of a battery over-current protection controller according to a second preferred embodiment of the present invention. The circuit over-current protection controller 400 utilizes the current sense circuit of FIG. 2 to determine whether a current outputted by a battery module 10 in a discharge state is greater than a predetermined current. As shown in FIG. 4, the battery over-current protection controller 400 includes a voltage detection unit 410, a logic control unit 420, and a current sense circuit 430. In comparison with the first preferred embodiment illustrated in FIG. 3, the battery module 10 of the second embodiment includes a plurality of battery cells Cell1, Cell2 and Cell3 connected in series. The voltage detection unit 410 generates a voltage control signal DD according to a battery voltage detection signal DET1 between the battery cells Cell1 and Cell2 or a battery voltage detection signal DET2 between the battery cells Cell2 and Cell3. A current detection circuit 40 is coupled between a negative end of the battery module 10 and a first pin 401, and generates a current detection signal D1 based on the value of a current flowing therethrough. In this embodiment, the current detection circuit 40 is a resistor. The current sense circuit 430 receives the current detection signal D1 through the first pin 401 to thereby determine whether to generate an over-current protection signal CC. The logic control unit 420 receives the voltage control signal DD and the over-current protection signal CC to thereby control turn-on or turn-off of a charge-discharge switch.

The current sense circuit 430 includes a reference voltage generation unit REF, a voltage dividing unit 434, and a comparison unit 432. The reference voltage generation unit REF is coupled between a second pin 402 and a third pin 403 to generate a reference voltage V2. The second pin 402 is coupled to the positive end of the battery module 10, and the third pin 403 is coupled to the negative end of the battery module 10. The voltage dividing unit 434 has one end coupled to the third pin 403 and another end coupled to the reference voltage V2 to generate a voltage dividing signal D2 according to the reference voltage V2. The voltage dividing unit 434 includes a first impedance R1 and a second impedance R2 connected in series, and divides the reference voltage V2 so as to reduce the voltage drift of the reference voltage V2 due to temperature change. In this regard, the first impedance R1 is preferably less than the second impedance R2 in value, such that the divided voltage across the voltage dividing unit 434 is small so as to achieve an even lesser voltage drift. An inverting input terminal of the comparison unit 432 receives the voltage dividing signal D2, and a non-inverting input terminal of the comparison unit 432 receives the current detection signal D1. When the level of the current detection signal D1 is greater than the level of the voltage dividing signal D2, the comparison unit 432 generates an over-current protection signal CC. That is, when the current flowing through the current detection circuit 40 is greater than a predetermined current, such that the voltage across the current detection circuit 40 is greater than the current detection signal D1, the comparison unit 432 generates an over-current protection signal CC. In this case, the logic control unit 420 controls the charge-discharge switch to turn off, such that the battery module 10 stops discharging to avoid damage of the battery module 10 due to over-current.

The voltage detection unit 410 is coupled between the second pin 402 and the third pin 403 to detect whether the voltages of the battery cells Cell1, Cell2 and Cell3 of the battery module 10 are insufficient. When the voltage of any of the battery cells Cell1, Cell2 and Cell3 is less than a predetermined voltage (for example, when the battery cell with insufficient voltage is in an over-discharge state), the voltage detection unit 410 outputs a voltage control signal DD to the logic control unit 420. In this case, the logic control unit 420 controls the charge-discharge switch to turn off, such that the battery module 10 stops discharging to avoid damage of the battery module 10.

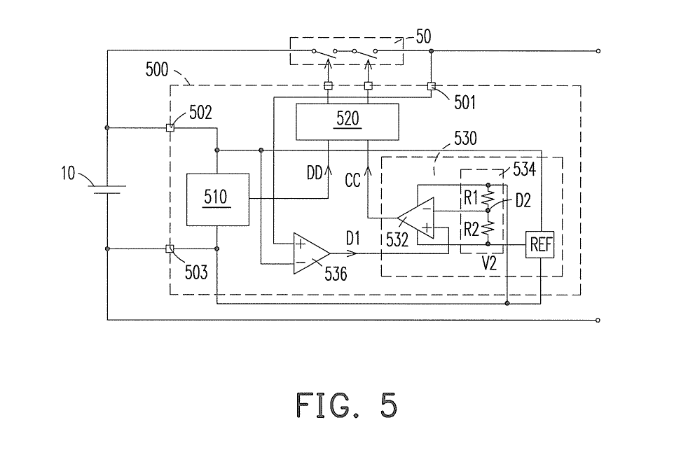

FIG. 5 is a circuit diagram of a battery over-current protection controller according to a third preferred embodiment of the present invention. In comparison with the first preferred embodiment illustrated in FIG. 3, the battery over-current protection controller 500 utilizes the current sense circuit of FIG. 2 to determine whether a charging current of a battery module 10 in a charge state is greater than a predetermined current. As shown in FIG. 5, the battery over-current protection controller 500 includes a voltage detection unit 510, a logic control unit 520, and a current sense circuit 530. The voltage detection unit 510 detects a voltage of the battery module 10 to generate a voltage control signal DD. A current detection circuit 50 is coupled to the battery module 10. A current detection unit 536 is coupled to, at a non-inverting input thereof, a high potential end of the current detection circuit 50 through a first pin 501, and is coupled to, at an inverting input thereof, a low potential end of the current detection circuit 50 (i.e. a positive end of the battery module 10) through a second pin 502, to thereby generate a current detection signal D1 according to a potential difference between the first pin 501 and the second pin 502. The current sense circuit 530 receives the current detection signal D1 to thereby determine whether to generate an over-current protection signal CC. The logic control unit 520 receives the voltage control signal DD and the over-current protection signal CC to thereby control turn-on or turn-off of a charge-discharge switch. In this embodiment, the charge-discharge switch is the current detection circuit 50.

The current sense circuit 530 includes a reference voltage generation unit REF, a voltage dividing unit 534, and a comparison unit 532. The reference voltage generation unit REF is coupled to the second pin 502 and a third pin 503 to generate a reference voltage V2. The second pin 502 is coupled to the positive end of the battery module 10, and the third pin 503 is coupled to a negative end of the battery module 10. The voltage dividing unit 534 has one end coupled to the third pin 503 and another end coupled to the reference voltage V2 so as to generate a voltage dividing signal D2 according to the reference voltage V2. The voltage dividing unit 534 includes a first impedance R1 and a second impedance R2 connected in series, and divides the reference voltage V2 to reduce a voltage drift of the reference voltage V2 due to temperature change. In this regard, the first impedance R1 is preferably less than the second impedance R2 in value, such that the divided voltage across the voltage dividing unit 534 is small so as to achieve an even lesser voltage drift. An inverting input terminal of the comparison unit 532 receives the voltage dividing signal D2 and a non-inverting input terminal of the comparison unit 532 receives the current detection signal D1. When the level of the current detection signal D1 is greater than the level of the voltage dividing signal D2, the comparison unit 532 generates an over-current protection signal CC. That is, when a current flowing through the current detection circuit 50 is greater than a predetermined current, such that the voltage across the current detection circuit 50 is greater than a voltage value thus making the level of the current detection signal D1 to be greater than the level of the voltage dividing signal D2, the comparison unit 532 generates an over-current protection signal CC. In this case, the logic control circuit 520 controls a charge-discharge switch (i.e. the current detection circuit 50) to turn off, such that the battery module 10 stops being charged to avoid damage of the battery module 10 due to over-current.

The voltage detection unit 510 is coupled between the second pin 502 and the third pin 503 to detect whether the voltage of the battery module 10 is too high. When the voltage of the battery module 10 is greater than a second predetermined voltage (for example, when the battery module 10 is in an over-charge state), the voltage detection unit 510 outputs a voltage control signal DD to the logic control unit 520. In this case, the logic control unit 520 controls the charge-discharge switch to turn off, such that the battery module 10 stops being charged to avoid damage of the battery module 10.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A current sense circuit, comprising:
a reference voltage generation unit coupled between a first common potential and a second common potential, for generating a reference voltage;
a voltage dividing unit having one end coupled to one of the first common potential and the second common potential, so as to generate a voltage dividing signal accordingly; and
a comparison unit coupled to the reference voltage to receive power needed for operation and receive the voltage dividing signal and a current detection signal indicative of a value of a current, so as to determine whether the current is greater than a predetermined current, wherein the comparison unit generates an over-current protection signal when the current is greater than the predetermined current.

2. The current sense circuit according to claim 1, wherein the first common potential is one of a positive end and a negative end of a battery module.

3. The current sense circuit according to claim 2, wherein the first common potential is coupled to a charge-discharge switch and the current detection signal is generated at an output end of the charge-discharge switch.

4. The current sense circuit according to claim 1, wherein the voltage dividing unit comprises a first impedance and a second impedance connected in series.

5. The current sense circuit according to claim 1, wherein the voltage dividing unit is further coupled to the reference voltage for generating the voltage dividing signal according to the reference voltage.

6. The current sense circuit according to claim 1, wherein the voltage dividing unit has another end receiving the reference voltage so as to generate the voltage dividing signal according to the reference voltage and one of the first common potential and the second common potential.

7. A battery over-current protection controller, comprising:
a first pin coupled to one end of a current detection circuit;
a second pin coupled to a positive end of a battery module;
a third pin coupled to a negative end of the battery module; and
a current sense circuit adapted to sense whether a current of the battery module is greater than a predetermined current according to a current detection signal indicative of a value of a current flowing through the current detection circuit, the current sense circuit comprising:
a reference voltage generation unit coupled between the second pin and the third pin to generate a reference voltage;
a voltage dividing unit having one end coupled to the reference voltage so as to generate a voltage dividing signal according to the reference voltage; and
a comparison unit adapted to receive the voltage dividing signal and the current detection signal, for generating an over-current protection signal when the current is greater than the predetermined current.

8. The battery over-current protection controller according to claim 7, wherein the current detection circuit is a charge-discharge switch coupled to the positive or negative end of the battery module.

9. The battery over-current protection controller according to claim 8, further comprising a logic control unit adapted to turn off the charge-discharge switch upon receiving the over-current protection signal.

10. The battery over-current protection controller according to claim 7, wherein the comparison unit is coupled to the reference voltage to receive power needed for operation.

11. The battery over-current protection controller according to claim 7, wherein the voltage dividing unit comprises a first impedance and a second impedance connected in series, and the first impedance is less than the second impedance in value.
